(19) United States
(12) Patent Application Publication
(10) Pub. No.: US 2011/0302744 A1
(43) Pub. Date: Dec. 15, 2011

(54) Multi-purpose Universal Grip

(76) Inventor: Pamela Funderburg Heckel, Wyoming, OH (US)

(21) Appl. No.: 13/157,811

(22) Filed: Jun. 10, 2011

Related U.S. Application Data
(60) Provisional application No. 61/353,900, filed on Jun. 11, 2010.

(51) Int. Cl. B25G 1/10

(52) U.S. Cl. 16/430

(57) ABSTRACT

The Multi-purpose Universal Grip is an ergonomically designed grip for use by persons with a thumb and one or more fingers. The grip itself may be manufactured as an accessory or attached to or part of a shaft, wheel, handle, surface, etc.

### CROSS REFERENCE TO RELATE APPLICATION

Provisional patent application #61353900 filed 10 Jun. 2010, titled Multi-purpose sponge applicator with universal grip

### BACKGROUND

This invention relates to an apparatus for holding a tool, equipment or instrument during operation of said device. The term “universal” implies that various disabilities of the hand/fingers have been considered in the design of the grip. The term “multipurpose” implies that the grip itself may be manufactured as an accessory or attached to or part of a shaft, wheel, handle, surface, etc.

Various grips may be known. However, the distinguishing features of the multipurpose universal grip make it usable by persons with a thumb and one or more fingers on a hand, with deformed fingers, or with normal fingers. The present invention may accommodate one or two hands.

### SUMMARY OF THE INVENTION

The present invention is directed to holding a tool, surface or instrument and may be attached to or part of a shaft, wheel, surface or handle. The grip may be two-handed, ambidextrous or right- or left-handed. The top and bottom surfaces of the grip may be flat, textured, circular or elliptical. The top and bottom surfaces may be identical.

An indentation on the top surface may serve as an anchor point for the thumb. This indentation may run the entire length of the grip to accommodate two hands. The indentation may be shaped to accommodate one or two thumbs. An indentation may be on the bottom surface to serve as an anchor point for the thumb.

There are sloped indentations for the tips of the fingers on the sides of the grip. These indentations direct the finger tips away from the top surface of the device. There may be ridges between the indentations on the sides of the device. Indentations and ridges do not encompass the circumference of the device.

These and other features, aspects and advantages of the present invention will become better understood with reference to the following drawings, description and claims.

### BRIEF DESCRIPTION OF THE DRAWINGS

FIG. 1 The top view of the grip

FIG. 2 Artist's Rendering of the Invention when used as an applicator

FIG. 3 is a top plan view of the grip and handle of a 15″ sponge applicator embodiment.

FIG. 4 is a side view of the grip and handle of a 15″ sponge applicator embodiment.

FIG. 5 is a side view of the grip and handle of a 15″ sponge applicator embodiment.

FIG. 6 is a sponge 3×3×½ to be attached to a 15″ sponge applicator embodiment

### DETAILED DESCRIPTION OF THE INVENTION

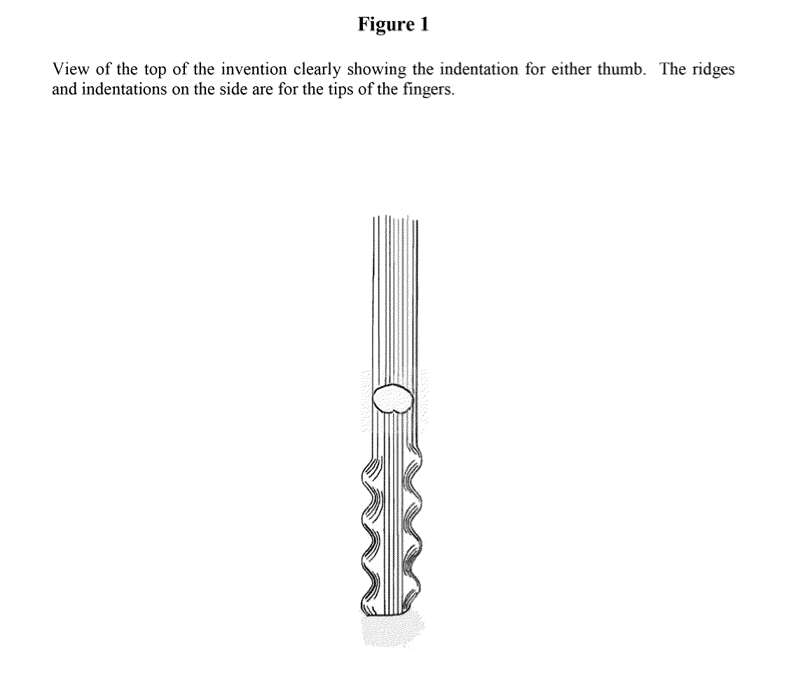

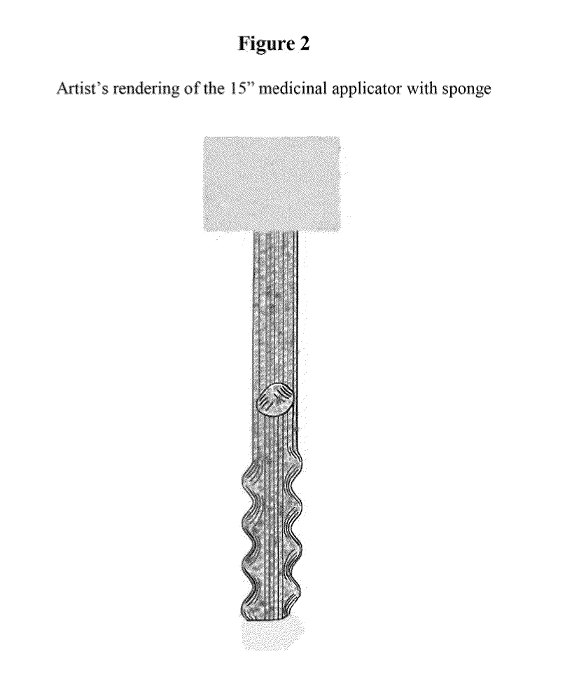

The multipurpose universal grip may be designed to be held by a thumb and one finger, by any mechanical device that substitutes for a thumb and one finger, or by any other method that allows the user to simultaneously grasp two opposite surfaces without bending the wrist. When holding the invention with a normal hand, a straight line can be drawn from the elbow to the tip of the thumb. The invention may be attached to a rigid shaft, wheel, surface or handle. In one version, the invention has no movable parts and no mechanical fasteners. The invention may be solid or hollow and may or may not have a reservoir for liquids. In addition, the bottom portion of the invention closest to the user may have a spiral, contoured shape. The invention has sloped indentations for fingers on the sides and flat, textured, circular or elliptical surfaces on the top and bottom faces. See FIG. 1. The invention is in one version “disposable”. In addition, the exterior surface of the invention may have a textured surface as shown in FIG. 2.

The invention may be made of formed plastic, metal or other rigid or semi-rigid material. The invention may be ambidextrous. The top and bottom may be identical. The spiral, contours on the sides of the invention may facilitate its grasp by an individual with a thumb and one or more fingers, with deformed fingers, or with normal fingers. The grip may be modified to accommodate one or two hands. This ergonomic device may be held equally well in either the left or right hand without bending the wrist.

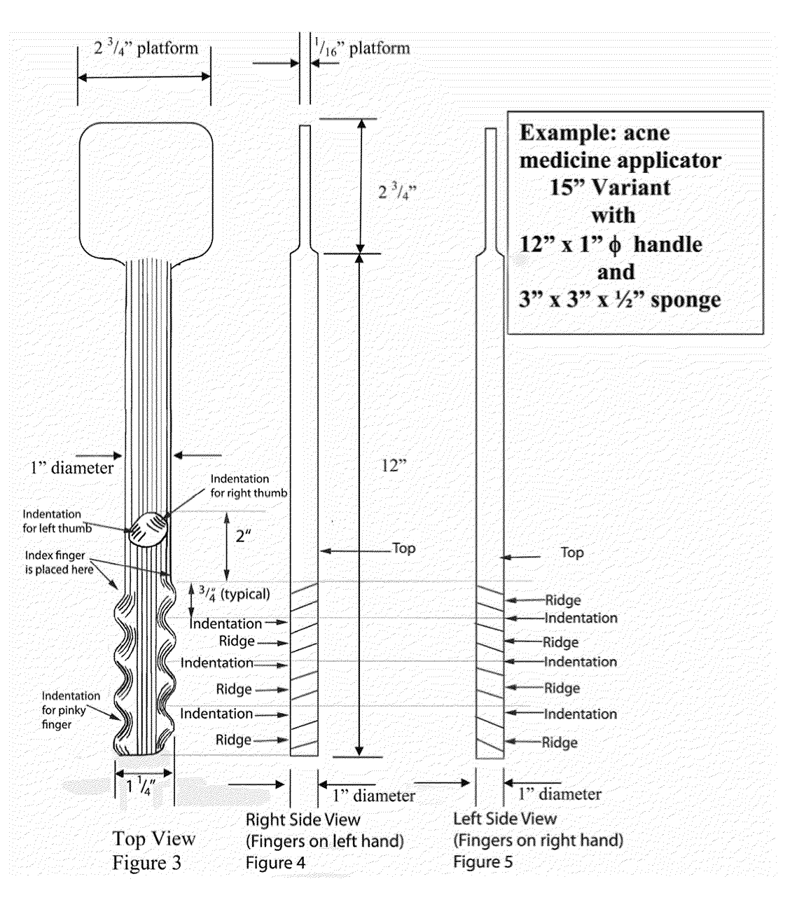

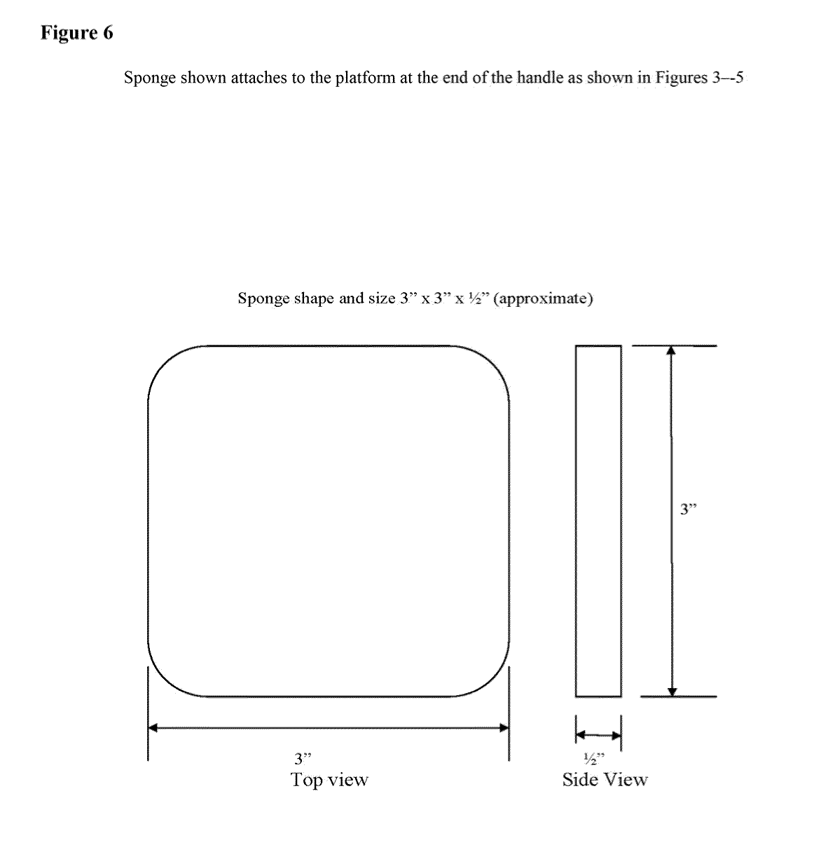

In one embodiment, shown in FIGS. 2-5, the invention is attached to a handle that connects to a sponge. One purpose of the embodiment is to extend the reach of the user for the purpose of applying liquids, including lotions and/or medications to body surfaces such as the back or to apply liquids such as paint or tar to building surfaces or to apply cleaning agents to other types of surfaces. Individuals of all ages may have limited ability to reach certain body parts in particular the back for the application of lotions and topical medicines. In addition a person may wish to spread a liquid on a surface which is otherwise unreachable. See FIGS. 3-5 for the 15″ variant used to apply acne medicine to the back. This version can be sized to fit inside a woman's purse, a beach bag or a gym bag. The entire assemble can be washed. In one version, the sponge cannot be detached from the handle. The sponge may be made from material that does not absorb lotion/medication. For example, the sponge material to be used with sunscreen should be lipophobic. The sponge material to be used with acne medications should be hydrophobic. The sponge may be re-usable and washable or disposable. The sponge on the 15″ variant is approximately the size and shape of the palm of an adult human hand as shown in FIG. 6.

Versions describe herein an ergonomically friendly applicator for applying liquids. The sponge and the handle above the invention may be symmetric about the longitudinal axis. The invention is designed so that either the left or right hand can be used. The invention may be modified to accommodate two-handed use, for example, as the grip on a golf club. The overall size of the device and the material choice for the invention may vary depending on the. application. For example a length up to 60″ may be suitable for cleaning or maintenance tasks while the 15″ embodiment may be used to apply lotions/medicines to the mid-back. These examples are not intended to limit the application of the invention.

The invention may be incorporated with other gadgets including but not limited to kitchen tools such as knives and spatulas; work tools such as screwdrivers and flashlights; recreational items such as golf clubs and pogo sticks; weapons and steering mechanisms. All dimensions shown in FIGS. 1-6 may change, to accommodate the application.

1. The invention is designed to be held by a thumb and one finger, by two fingers, by any mechanical device that substitutes for a thumb and one finger, or by any other method that allows the user to simultaneously grasp two opposite surfaces without bending the wrist. When holding the invention with a normal hand, a straight line can be drawn from the elbow to the tip of the thumb.

2. The top and bottom surfaces of the invention may be flat, textured, circular or elliptical. The top and bottom surfaces may be identical, but are easily distinguishable from the sides.

3. An indentation on the top surface provides an anchor point for the thumb. This indentation may run the entire length of the grip to allow enough space for two hands to hold the device. The indentation may be shaped to accommodate one or two thumbs.

4. There are sloped indentations for the tips of the fingers on the sides of the invention. These indentations direct the finger tips away from the top surface of the device. There may be ridges between the indentations on the sides of the device. Indentations and ridges do not encompass the circumference of the device.
